(19) United States
(12) Patent Application Publication
(10) Pub. No.: US 2009/0213851 A1
(43) Pub. Date: Aug. 27, 2009

(54) MULTIPORT DEVICE

(76) Inventors: Tae-Hyoung Kim, Gunpo-si (KR); Jong-Ik Cho, Dongdaemun-gu (KR)

Correspondence Address: SHERR & VAUGHN, PLLC, 620 HERNDON PARKWAY, SUITE 320, HERNDON, VA, 20170, US

(21) Appl. No.: 12/368,261

(22) Filed: Feb. 9, 2009

(30) Foreign Application Priority Data
Feb. 27, 2008 (KR) 10-2008-0017780

(51) Int. Cl. H04L 12/56

(52) U.S. Cl. 370/389

(57) ABSTRACT

A multiport device capable of supporting a plurality of IP (Internet Protocol) devices with a single IP address includes a plurality of internal terminals coupled to the plurality of the IP devices, each configured to transmit a packet with a same IP address and a multiport unit configured to translate a port number of the transmitted packet to transmit the transformed packet. Therefore, the multiport device may support a plurality of IP devices with a single IP address through a packet translation.

### CROSS-REFERENCE TO RELATED APPLICATION

This application claims the benefit of Korean Patent Application No. 2008-17780, filed Feb. 27, 2008, the contents of which are hereby incorporated herein by reference in their entirety.

### BACKGROUND

1. Technical Field

This application relates to a multiport device, and more particularly, to a multiport device capable of supporting a plurality of IP (Internet Protocol) devices with a single IP address.

2. Description of Related Art

Nowadays, according to a development of an infrastructure for the Internet, an IP (Internet Protocol) device such as a computer, a telephone and a television may be connected to the Internet, and a user may use the Internet at home. If necessary, the user may build a home networking system for connecting a plurality of IP devices to the Internet.

When the user allocates the plurality of the IP devices to different IP addresses, a cost of the home networking system may be high and an IP address resource may be exhausted.

Therefore, if there is a solution to supporting the plurality of the IP devices with a single IP address, the user may economically use the Internet and prevent an exhaustion of the IP address resource.

### SUMMARY

In some embodiments, a multiport device capable of supporting a plurality of IP (Internet Protocol) devices with a single IP address includes a plurality of internal terminals coupled to the plurality of the IP devices, each configured to transmit a packet with a same IP address and a multiport unit configured to translate a port number of the transmitted packet to transmit the transformed packet.

The multiport unit may translate a MAC (Medium Access Control) address of the transmitted packet into a representative MAC address when the MAC address of the transmitted packet does not correspond to the representative MAC address.

The multiport unit may set the representative MAC address as a MAC address of an IP device among the plurality of the IP devices and the IP device corresponds to an IP device transmitting a packet for a first time.

The multiport unit may modify a checksum in the transmitted packet when the transmitted packet is translated.

The multiport unit may check whether the transmitted packet has a predetermined purpose, and, if not, may translate at least one of bits configuring the port number of the transmitted packet into an identifier indicating each of the plurality of the internal terminals or may translate the port number of the transmitted packet into a reserved port number.

The multiport unit may translate the at least one of the bits into the identifier when the at least one of the bits is not used and may translate the port number of the transmitted packet into the reserved port number when the at least one of the bits is used.

The multiport unit may include a memory comprising at least one table and a reserved port pool, the at least one table storing, per each of the plurality of the internal terminals, the port number of the transmitted packet and the reserved port number, the reserved port pool managing unused reserved port numbers, and a control unit configured to find one of the unused reserved port numbers when the at least one of the bits is used and configured to store the port number of the transmitted packet and the found port number into the at least one table.

The multiport unit may manage an internal finite state machine according to a use of the transmitted packet when the transmitted packet has a predetermined use.

In some embodiments, a multiport device capable of supporting a plurality of IP (Internet Protocol) devices with a single IP address includes a plurality of internal terminals, an external terminal configured to receive a packet from externals, and a multiport unit configured to translate a port number of the received packet into an original port number to transmit the translated packet to one of the plurality of the internal terminals.

The multiport unit may translate a MAC (Medium Access Control) address of the received packet into one of the plurality of the internal terminals. The multiport unit may modify a checksum in the received packet when the received packet is translated.

The multiport unit may check whether the received packet has a predetermined purpose, and, if not, may translate the port number of the received packet into the original port number according to whether the port number of the received packet corresponds to the original port number or may translate at least one of bits configuring the port number of the received packet.

When the port number of the received packet corresponds to the reserved port number, the multiport unit may find a first internal terminal associated with the reserved port number and the original port number and may translate the received packet based on the original port number to transmit the translated packet to the first internal terminal. When the port number of the received packet does not correspond to the reserved port number, the multiport unit may find a second terminal corresponding to at least one of the bits and may translate the received packet to transmit the translated packet to the second internal terminal.

The multiport unit may include a memory comprising at least one table and a reserved port pool, the at least one table storing, per each of the plurality of the internal terminals, the port number of the received packet and the reserved port number, the reserved port pool managing unused reserved port numbers, and a control unit configured to find the at least one table for the original port number associated with the reserved port number when the port number of the received packet corresponds to the reserved port number and configured to transmit the translated packet.

The multiport unit may manage an internal finite state machine according to a use of the received packet when the received packet has a predetermined use.

In some embodiments, a multiport device capable of supporting a plurality of IP (Internet Protocol) devices with a single IP address includes a plurality of internal terminals coupled to a plurality of IP (Internet Protocol) devices, the plurality of the IP devices transmitting a packet, and a multiport unit configured to transmit a first packet without translation and a second packet with translation, the first packet being transmitted from at least one first IP device, each of the at least one first IP device having a different IP address among the plurality of the IP devices, the second packet being transmitted from second IP devices, the second IP devices having a same IP address among the plurality of the IP devices.

The multi port unit may translate a MAC (Medium Access Control) address of the first packet into a representative MAC address when the MAC address of the first packet does not correspond to the representative MAC address.

The multiport unit may modify a checksum in the first packet when the first packet is translated. The multiport unit may check whether the first packet has a predetermined purpose, and, if not, may translate at least one of bits configuring the port number of the first packet into an identifier indicating each of the plurality of the internal terminals or may translate the port number of the first packet into a reserved port number.

The multiport unit may translate the at least one of the bits into the identifier when the at least one of the bits is not used and may translate the port number of the first packet into the reserved port number when the at least one of the bits is used.

### BRIEF DESCRIPTION OF THE DRAWINGS

FIGS. 1 and 2 are diagrams for illustrating a configuration of a home networking system according to an example embodiment of the described technology.

FIG. 3 is a block diagram illustrating an multiport device in FIGS. 1 and 2.

FIG. 4 is a diagram for illustrating a memory in FIG. 3.

FIGS. 5 and 6 are flowcharts for illustrating a procedure where a packet is transmitted from a plurality of internal terminals to an external terminal.

FIGS. 7 and 8 are a flowchart illustrating a procedure where a packet is transmitted from an external terminal to a plurality of internal terminals.

FIGS. 9 and 10 are diagrams for illustrating a configuration of a home networking system according to another example embodiment of the described technology.

### DETAILED DESCRIPTION

The technology is described more fully hereinafter with reference to the accompanying drawings, in which example embodiments of the technology are illustrated. The technology may, however, be embodied in many different forms and should not be construed as limited to the example embodiments set forth herein. Rather, these example embodiments are provided to fully enable those of ordinary skill in the art to embody and practice the technology.

Terms used herein are to be understood as described below.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element.

The term “and/or” includes any and all combinations of one or more of the associated listed items. For example, “a first item, a second item and/or a third item” denotes at least one of the first item, the second item and the third item, that is, all the combinations of the first, second and third items including the first item, the second item and the third item each.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements, e.g., “between” versus “directly between” and “adjacent” versus “directly adjacent”, should be interpreted in a like fashion.

As used herein, the singular forms “a”, “an” and “the” are intended to include the plural forms as well, unless the context clearly indicates otherwise. It will be further understood that the terms “comprises”, “comprising”, “includes” and/or “including” when used herein, specify the presence of stated features, integers, steps, operations, elements and/or components, but do not preclude the presence or addition of one or more other features, integers, steps, operations, elements, components and/or groups thereof.

Respective steps described herein may be performed in a different order than that which is explicitly described. In other words, the respective steps may be performed in the same order as described, simultaneously, or in a reverse order.

Unless defined otherwise, all terms used herein have the same meaning as commonly understood by those of skill in the art. Such terms as those defined in a generally used dictionary are to be interpreted to have the meanings equal to the contextual meanings in the relevant field of art, and are not to be interpreted to have ideal or excessively formal meanings unless clearly defined in the present specification.

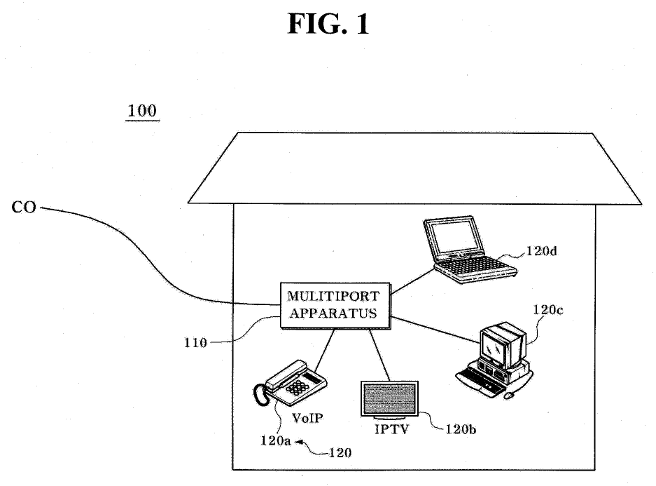

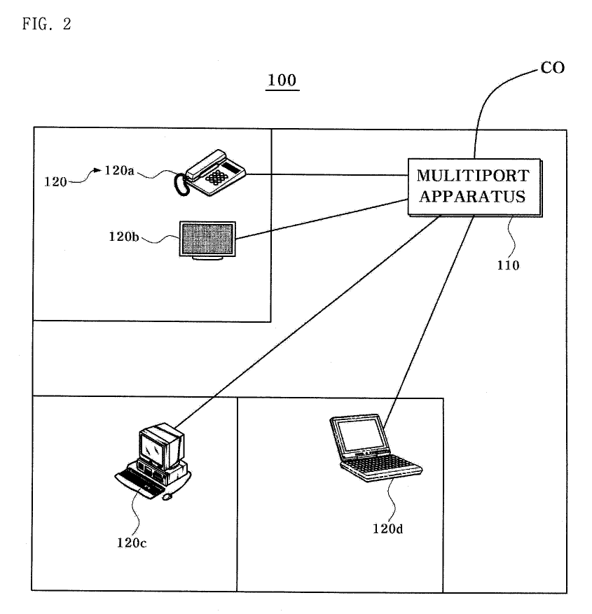

FIGS. 1 and 2 are diagrams for illustrating a configuration of a home networking system according to an example embodiment of the described technology.

Referring to FIGS. 1 and 2, the home networking system 100 includes a multiport device 110 and an IP (Internet Protocol) device 120. The IP device 120 may correspond to any device connectable through Internet Protocol. For example, the IP device 120 may include a telephone 120a supporting VoIP (Voice over IP), an IPTV (IP Television) 120b, a desktop computer 120c and a notebook computer 120d.

The multiport device 110 is coupled to a central office (e.g., telephone office) (not shown) and may support a plurality of IP devices with a single IP address. In one embodiment, the multiport device 110 may be directly coupled to the central office. In another embodiment, the multiport device 110 may be indirectly coupled to the central office. As a result, the home networking system 100 may economically be built and an IP address resource may be effectively used.

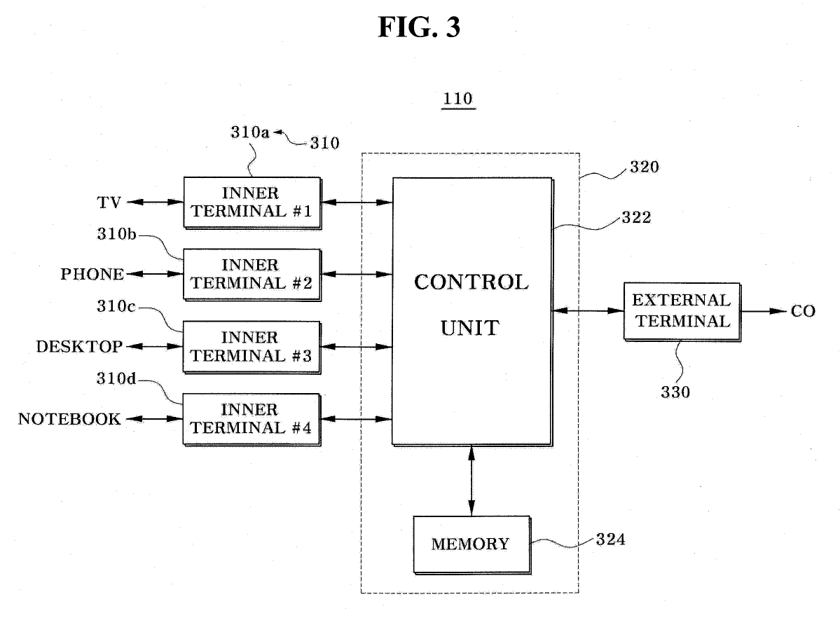

FIG. 3 is a block diagram illustrating an multiport device in FIGS. 1 and 2.

Referring to FIG. 3, the multiport device 110 includes a plurality of internal terminals 310, a multiport unit 320 and an external terminal 330.

Hereinafter, IP devices are assumed to have a same IP address and a first example embodiment of the described technology will be described.

The plurality of the internal terminals 310 are coupled to a plurality of IP devices and each of the plurality of the IP devices transmits a packet with the same IP address. For example, the plurality of the IP devices may include a telephone 120a supporting VoIP (Voice over IP), an IPTV (IP Television) 120b, a desktop computer 120c and a notebook computer 120d.

In one embodiment, each of the plurality of the internal terminals may include a buffer (not shown) and may buffer a packet transmitted from another IP device. The buffer (not shown) may temporarily store the packet when the plurality of the IP devices communicates with the multiport unit 320.

The multiport unit 320 may include a control unit 322 and a memory 324. The multiport unit 320 may translate a port number of a packet transmitted from the plurality of the internal terminals 310 to transmit the translated packet to the central office. The multiport unit 320 may translate a port number of a packet received from the external terminal 330 into an original port number to transmit the translated packet to the plurality of the internal terminals 310.

The external terminal 330 receives a packet from externals. In one embodiment, the external terminal 330 may directly or indirectly be coupled to the central office. Also, in one embodiment, the external terminal 330 may include a buffer (not shown) and may buffer a packet received from externals when the packet is received from externals.

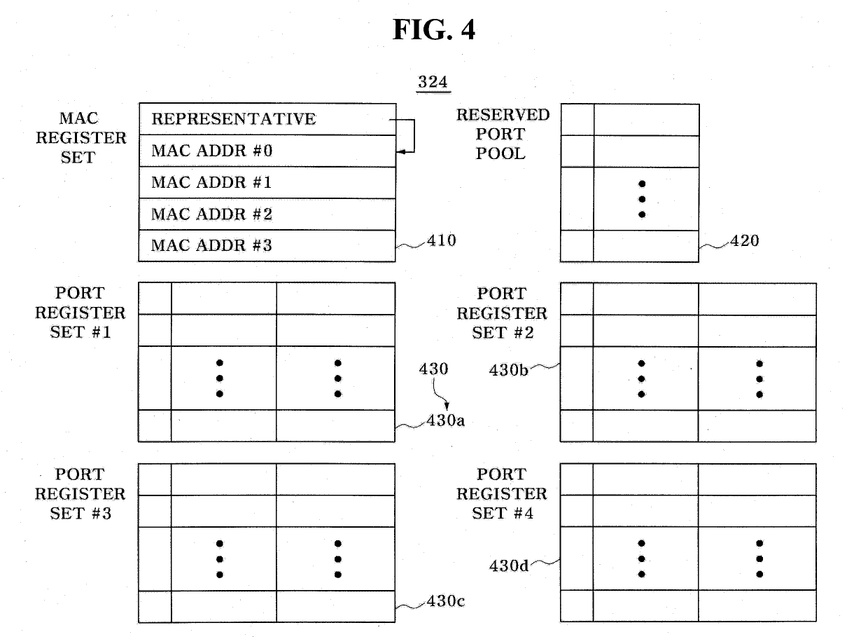

FIG. 4 is a diagram for illustrating a memory in FIG. 3.

Referring to FIG. 4, the memory 324 may be implemented with a register file, and the memory 324 includes a MAC (Medium Access Control) register set 410, a reserved port pool 420 and a plurality of port register sets 430.

The MAC register set 410 corresponds to a space for storing a MAC address. In one embodiment, the MAC register set 410 may be implemented with a register file and may include a space for a representative MAC address and a space for the plurality of the IP devices.

The reserved port pool 420 includes a table having a user flag field (left-side column) and a reserved port (right-side column). The user flag field indicates whether an associated reserved port is used and the reserved port indicates a reserved port number.

The plurality of the port register sets 430 respectively includes a table having a user flag field (left-side field), an original port (center column) and a reserved port (right-side column). The user flag field indicates whether an associated original port and reserved port are used, the original port indicates a port number originally used by an IP device, and the reserved port indicates a reserved port number stored in the reserved port pool 420.

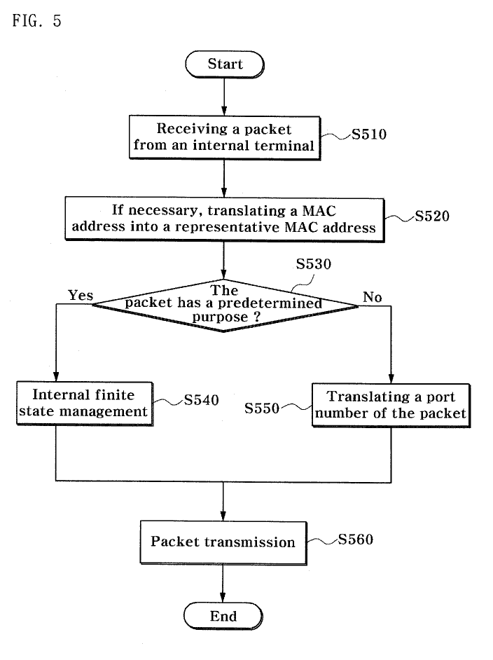

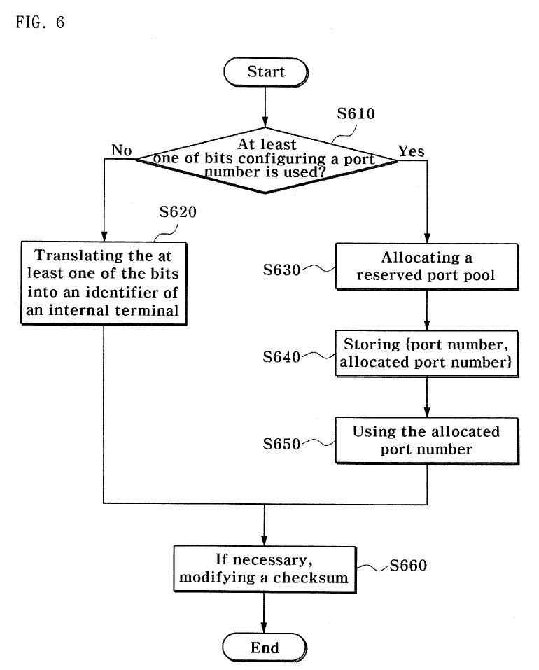

FIGS. 5 and 6 are flowcharts for illustrating a procedure where a packet is transmitted from a plurality of internal terminals to an external terminal.

Hereinafter, a procedure where a packet is transmitted from a plurality of internal terminals 310 to an external terminal will be described with reference to FIGS. 5 and 6.

The control unit 322 receives a packet from each of the plurality of the internal terminals 310 (Step S510). For example, the control unit 322 may receive a packet from an internal terminal 310a.

The control unit 322 translates a MAC address of the packet into a representative MAC address when the MAC address of the packet does not correspond to the representative MAC address (Step S520). This is because an external device coupled to an external terminal 330 recognizes IP devices coupled to each of the plurality of the internal terminals 310 as a single device. In one embodiment, the representative MAC address may correspond to an MAC address of an IP device transmitting a packet for a first time.

For example, when the representative MAC address corresponds to a MAC address of an internal terminal 310b, the control unit 322 may translate a MAC address of a packet transmitted from the internal terminal 310a into a MAC address of the internal terminal 310b.

The control unit 322 checks whether the packet transmitted from each of the plurality of the internal terminals 310 has a predetermined purpose (Step S530). For example, the predetermined purpose may correspond to a predefined service in the Internet. The predefined service may not change a port number for a service and may correspond to a DHCP (Dynamic Host Configuration Protocol) service, an ARP (Address Resolution Protocol) service or an ICMP (Internet Control Message Protocol) service. The control unit 322 may translate at least one of bits configuring the port number of the packet into an identifier indicating each of the plurality of the internal terminals 310 or translate a port number of the packet into a reserved port number.

When the packet transmitted from each of the plurality of the internal terminals 310 has a predetermined purpose, the control unit 322 manages an internal finite state machine according to a use of the packet (Step S540). For example, when a DHCP packet is transmitted from the internal terminal 310a, the control unit 322 stores the fact that the DHCP packet is transmitted from the internal terminal 310a and when a reply to the DHCP packet is received, the control unit 322 transmits a reply to an IP device coupled to the internal terminal 310a.

When the packet transmitted from each of the plurality of the internal terminals 310 does not have a predetermined purpose, the control unit translates a port number of the packet (Step S550). That is, the control unit 322 translates at least one of bits configuring the port number of the packet into an identifier indicating each of the plurality of the internal terminals 310 or translates the port number of the packet into a reserved port number.

The control unit 322 transmits the translated packet to an external device coupled to the external terminal 330 (Step S560). Hereinafter, an example procedure of Step S550 is described with reference to FIG. 6.

The control unit 322 checks whether at least one of bits configuring the port number of the packet transmitted from each of the plurality of the internal terminals 310 is used (Step S610). For example, when the number of the plurality of the internal terminals 310 corresponds to 4, the bits may include two upper bits for the port number and when the two upper bits correspond to “00”, the control unit 322 may determine that the two upper bits are not used.

When the at least one of the bits is not used, the control unit 322 translates the at least one of the bits into an identifier indicating each of the plurality of the internal terminals 310 (Step S620).

For example, an identifier of the internal terminal 310a may correspond to a value of “00”, an identifier of the internal terminal 310b may correspond to a value of “01”, an identifier of the internal terminal 310c may correspond to a value of “10” and an identifier of the internal terminal 310d may correspond to a value of “11”.

For example, when the two upper bits correspond to a value of “00” and a corresponding packet is transmitted from the internal terminal 310b, the control unit 322 may translate the two upper bits into a value of “01”.

When the at least one of the bits is used, the control unit 322 translates the port number into a reserved port number. In more detail, the control unit 322 allocates an unused reserved port number from the reserved port pool 420 (Step S630), stores the port number and the allocated port number into the port register set 430 (Step S640), and translates the port number into the allocated port number (Step S650). That is, when the at least one of the bits is used, the control unit 322 finds the port pool 420 for the unused port number and stores the port number and the found port number into the port register set 430.

For example, when the two upper bits among the bits configuring the port number of the packet transmitted from the internal terminal 310a correspond to a value of “01”, “10” or “11”, the control unit 322 may find the reserved port pool 420 for the unused reserved port number and may store the port number and the found port number into a table of the port register set 430a. Then the control unit 322 may translate the port number into the found port number.

For another example, when the two upper bits among the bits configuring the port number of the packet transmitted from the internal terminal 310b correspond to a value of “01”, “10” or “11”, the control unit 322 may find the reserved port pool 420 for the unused reserved port number and may store the port number and the found port number into a table of the port register set 430b. Then the control unit 322 may translate the port number into the found port number.

The control unit 322 may modify a checksum in the packet when the packet is translated (Step S660). In one embodiment, the control unit 322 may re-calculate a checksum in the packet. In another embodiment, the control unit 322 may mark a checksum as unused. For example, when the packet corresponds to a UDP (User Datagram Protocol) packet, the control unit 322 may mark a checksum as a value of “0”.

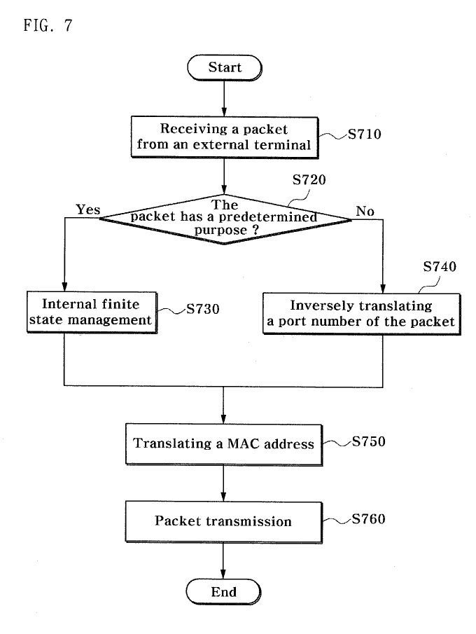

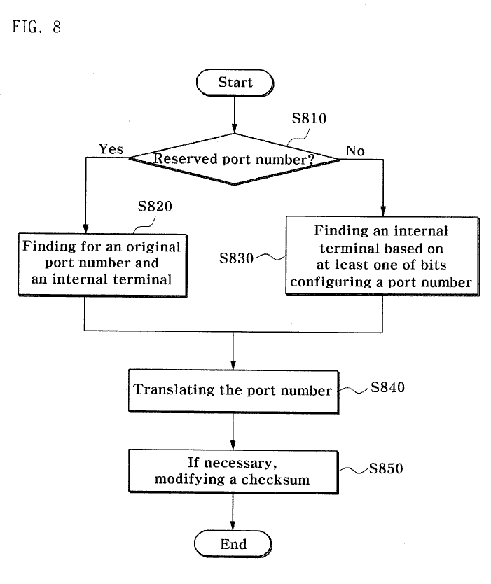

FIGS. 7 and 8 are a flowchart illustrating a procedure where a packet is transmitted from an external terminal to a plurality of internal terminals.

Hereinafter, the procedure where the packet is transmitted from the external terminal 330 to the plurality of the internal terminals 310 will be described with reference to FIGS. 7 and 8. Because the procedure is substantially equal to an inverse of the procedure in FIGS. 5 and 6, a similar description will be omitted.

The control unit 322 receives a packet from an external terminal 330 (Step S710).

The control unit 322 checks whether the packet received from the external terminal 330 has a predetermined purpose (Step S720). The predefined service may not change a port number for a service and may correspond to a DHCP (Dynamic Host Configuration Protocol) service, an ARP (Address Resolution Protocol) service or an ICMP (Internet Control Message Protocol) service. The control unit 322 may translate a port number of the received packet into an original port number or at least one of bits configuring the port number of the received packet.

When the received packet has the predetermined purpose, the control unit 322 manages an internal finite state machine according to a use of the packet (Step S730). For example, when a DHCP packet is transmitted from the internal terminal 310a, the control unit 322 stores the fact that the DHCP packet is transmitted from the internal terminal 310a and when a reply to the DHCP packet is received, the control unit 322 transmits a reply to an IP device coupled to the internal terminal 310a.

When the received packet does not have the predetermined purpose, the control unit 322 translates a port number of the received packet into an original port number (Step S740).

The control unit 322 translates a MAC address of the received packet into a corresponding MAC address of each of the plurality of the internal terminals 310. For example, when the corresponding MAC address corresponds to a MAC address of the internal terminal 310a, the control unit 322 may translate the MAC address of the received packet into the MAC address of the internal terminal 310a.

The control unit 322 transmits the packet to a corresponding internal terminal (Step S760). For example, when the corresponding internal terminal corresponds to the internal terminal 310a, the control unit 322 may transmit the packet to the internal terminal 310a. Hereinafter, an example procedure of Step S730 will be described with reference to FIG. 8.

The control unit 322 checks whether a port number of the packet corresponds to a reserved port number (Step S810). In one embodiment, the control unit 322 may find the reserved port pool 420 for the port number of the packet and may check whether the port number of the packet is used in the port register set 430. In another embodiment, the control unit 322 may not examine the reserved port pool 420 and may check whether the port number of the packet is used in the port register set 430.

When the port number of the packet corresponds to the reserved port number, the control unit 322 finds a corresponding internal terminal and an original port number based on the reserved port number (Step S820). In one embodiment, the control unit 322 may find the corresponding internal terminal from the reserved port number of the port register set 430 and may find the original port number from the reserved port number of the port register set 430.

When the port number of the packet does not correspond to the reserved port number, the control unit 322 finds a corresponding internal terminal based on at least one of bits configuring the port number of the packet (Step S830). In one embodiment, the control unit 322 may delete the at least one of the bits. That is, the control unit 322 may mark the at least one of the bits as a value of “00”.

The control unit 322 translates the packet based on the original port number or the at least one of the bits (Step S840).

The control unit 322 modifies a checksum in the packet when the packet is translated (Step S850). In one embodiment, the control unit 322 may re-calculate a checksum in the packet. In another embodiment, the control unit 322 may mark a checksum as unused. For example, when the packet corresponds to a UDP (User Datagram Protocol) packet, the control unit 322 may mark a checksum as a value of “0”.

Hereinafter, at least one of the IP devices 120 is assumed to have a different IP address and a second example embodiment of the described technology will be described. Because the second example embodiment is substantially similar to the first example embodiment, the second example embodiment may be implemented with reference to the first example embodiment.

A procedure where a packet is transmitted from the plurality of the internal terminals 310 to the external terminal 330 will be described with reference to FIG. 3.

Each of the plurality of the internal terminals 310 is coupled to a plurality of IP devices transmitting a packet. At least one of the IP devices has a different IP address and at least two of IP devices have a same IP address. In one embodiment, the multiport device 110 may set an IP address of all IP devices as a same IP address through DHCP. In another embodiment, the multiport device 110 may set an IP address of at least one of IP devices as a different IP address through DHCP. In still another embodiment, the multiport device 110 may set an IP address of all IP devices without using DHCP.

In case of an IP device having a different IP address, the multiport unit 320 transmits a packet without translation. In case of an IP device having a same IP address, the multiport unit 320 translates a port number of a packet to transmit the translated packet. That is, the multiport unit 320 translates a packet when an IP device having a same IP address transmits and does not translate a packet when an IP device having a different IP address transmits.

Because a packet translation procedure is described in FIGS. 3 through 6, a more detailed description about the packet translation procedure will be omitted.

A procedure where a packet is transmitted from the external terminal 330 to the plurality of the internal terminals 310 will be described with reference to FIG. 3.

Each of the plurality of the internal terminals 310 is coupled to an IP device and the external terminal 330 receives a packet. At least one of IP devices has a different IP address and at least two of the IP devices have a same IP address. In one embodiment, the multiport device 110 may set an IP address of all IP devices as a same IP address through DHCP. In another embodiment, the multiport device 110 may set an IP address of at least one of IP devices as a different IP address through DHCP. In still another embodiment, the multiport device 110 may set an IP address of all IP devices without using DHCP.

In case of an IP device having a different IP address, the multiport unit 320 transmits a packet without translation. In case of an IP device having a same IP address, the multiport unit 320 translates a port number of a packet to transmit the translated packet. That is, the multiport unit 320 translates a packet when an IP device having a same IP address transmits and does not translate a packet when an IP device having a different IP address transmits.

Because a packet translation procedure is described in FIGS. 3 through 6, a more detailed description about the packet translation procedure will be omitted.

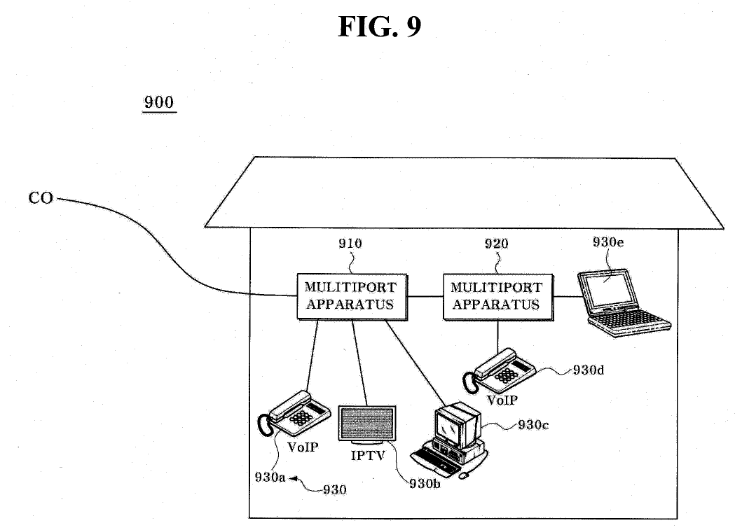

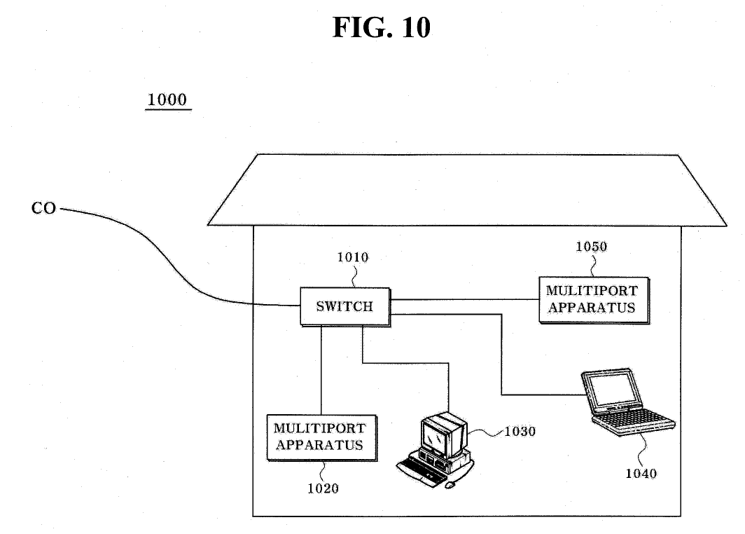

FIGS. 9 and 10 are diagrams for illustrating a configuration of a home networking system according to another example embodiment of the described technology.

Referring to FIG. 9, the home networking system 100 includes a first multiport device 910, a second multiport device 920 and IP devices 930.

The first and second multiport devices 910 and 920 may be coupled to each other.

In one embodiment, the first and second multiport devices 910 and 920 may use at least one of bits configuring a port number together. Therefore, the second multiport device 920 may mainly use a reserved port number for translation of a packet transmitted from or to the first multiport device 910.

That is, when both the first and second multiport devices 910 and 920 use two upper bits of the bits, the first multiport device 910 may translate the two upper bits and because the two upper bits are used by the first multiport device 910, the second multiport device 920 may use the reserved port number.

In another embodiment, the first multiport device 910 may use at least one of bits configuring a port number and the second multiport device 920 may use at least other of the bits. For example, the first multiport device 910 may use first two upper bits of the bits and the second multiport device 920 may use second two upper bits of the bits.

That is, the first multiport device 910 may use the first two upper bits to translate a packet and the second multiport device 920 may use the second two upper bits of the bits to translate a packet.

Because the procedure of the packet translation is described in FIGS. 3 through 8, a more detailed description for the packet translation will be omitted in FIG. 9.

Referring to FIG. 10, the home networking system 1000 includes a switch 1010, a first multiport device 1020, a second multiport device 1030, and IP devices 1030 and 1040.

Unlike the home networking system 900 in FIG. 9, the home networking system 1000 is coupled to a central office (e.g., a telephone office) through the switch 1010. The switch 1010 may correspond to an IP sharer and may manage a plurality of virtual or real IP addresses. Also, the switch 1010 may be used to enable an internal communication of the home networking system 1000.

Because the procedure of the packet translation in FIG. 3 through 8 may be easily adopted in the home networking system 1000, a more detailed description of the procedure of the packet translation will be omitted here.

The above-described example embodiments may have effects including the following advantages. However, not all of the example embodiments necessarily include all the advantages, and some example embodiments may have additional advantages. Thus, the scope of the present invention is not limited by the described advantages.

The multiport device may support a plurality of IP devices with a single IP address through a packet translation. Therefore, the multiport device may effectively use an IP address and may easily implement a home networking system.

Also, the multiport device may support both an IP device having a different IP address and an IP device having a same IP address. Therefore, the multiport device may effectively use an IP address.

1-20. (canceled)

21. A multiport device capable of supporting a plurality of Internet Protocol devices with a single Internet Protocol address, the multiport device comprising:
a plurality of internal terminals coupled to the plurality of the Internet Protocol devices, each configured to transmit a packet having an identical Internet Protocol address; and
a multiport unit configured to translate a port number of the transmitted packet to create a transformed packet, and to transmit the transformed packet.

22. The multiport device of claim 21, wherein the multiport unit translates a Medium Access Control address of the transmitted packet into a representative Medium Access Control address when the Medium Access Control address of the transmitted packet does not correspond to the representative Medium Access Control address.

23. The multiport device of claim 22, wherein the multiport unit sets the representative Medium Access Control address as a Medium Access Control address of an Internet Protocol device among the plurality of the Internet Protocol devices, the Internet Protocol device corresponding to an Internet Protocol device transmitting a packet for a first time.

24. The multiport device of claim 21, wherein the multiport unit modifies a checksum in the transmitted packet when the transmitted packet is translated.

25. The multiport device of claim 21, wherein the multiport unit is configured to check whether the transmitted packet has a predetermined purpose, and, if not, translate the port number of the transmitted packet into one of an identifier indicating each of the plurality of the internal terminals and a reserved port number.

26. The multiport device of claim 25, wherein the multiport unit translates the port number into the identifier when at least one bit in the port number is not used and translates the port number of the transmitted packet into the reserved port number when at least one of bit in the port number is used.

27. The multiport device of claim 26, wherein the multiport unit includes:
a memory comprising at least one table and a reserved port pool, the at least one table storing, per each of the plurality of the internal terminals, the port number of the transmitted packet and the reserved port number, the reserved port pool managing unused reserved port numbers; and
a control unit configured to find one of the unused reserved port numbers when the at least one bit is used and configured to store the port number of the transmitted packet and the found port number into the at least one table.

28. The multiport device of claim 25, wherein the multiport unit manages an internal finite state machine according to a use of the transmitted packet when the transmitted packet has a predetermined use.

29. A multiport device capable of supporting a plurality of Internet Protocol devices with a single Internet Protocol address, the multiport device comprising:
a plurality of internal terminals;
an external terminal configured to receive a packet from externals; and
a multiport unit configured to translate a port number of the received packet into an original port number and to transmit the translated packet to one of the plurality of internal terminals.

30. The multiport device of claim 29, wherein the multiport unit translates a Medium Access Control address of the received packet into one of the plurality of internal terminals.

31. The multiport device of claim 29, wherein the multiport unit modifies a checksum in the received packet when the received packet is translated.

32. The multiport device of claim 29, wherein the multiport unit is configured to check whether the received packet has a predetermined purpose, and, if not, translate the port number of the received packet into the original port number if the port number of the received packet corresponds to the original port number, and translate the port number of the received packet by changing at least one bit configuring the port number of the received packet if the port number of the received packet does not correspond to the original port number.

33. The multiport device of claim 32, wherein when the port number of the received packet corresponds to the reserved port number, the multiport unit finds a first internal terminal associated with the reserved port number and the original port number and translates the received packet based on the original port number to transmit the translated packet to the first internal terminal, and when the port number of the received packet does not correspond to the reserved port number, the multiport unit finds a second terminal corresponding to at least one of the bits and translates the received packet to transmit the translated packet to the second internal terminal.

34. The multiport device of claim 33, wherein the multiport unit includes
a memory comprising at least one table and a reserved port pool, the at least one table storing, per each of the plurality of the internal terminals, the port number of the received packet and the reserved port number, the reserved port pool managing unused reserved port numbers; and
a control unit configured to find the at least one table for the original port number associated with the reserved port number when the port number of the received packet corresponds to the reserved port number, and configured to transmit the translated packet.

35. The multiport device of claim 32, wherein the multiport unit manages an internal finite state machine according to a use of the received packet when the received packet has a predetermined use.

36. A multiport device capable of supporting a plurality of Internet Protocol devices with a single Internet Protocol address, the multiport device comprising:
a plurality of internal terminals coupled to a plurality of Internet Protocol devices, the plurality of the Internet Protocol devices configured to transmit at least one packet; and
a multiport unit configured to transmit a first packet type without translation and second packet type with translation, the first packet type being transmitted from at least one first type Internet Protocol device, the at least one first type Internet Protocol device having a different Internet Protocol address among the plurality of the Internet Protocol devices, the second packet type being transmitted from at least one second type Internet Protocol device, the second type Internet Protocol devices having a same Internet Protocol address among the plurality of the Internet Protocol devices.

37. The multiport device of claim 36, wherein the multi port unit translates a Medium Access Control address of the first packet into a representative Medium Access Control address when the Medium Access Control address of the first packet does not correspond to the representative Medium Access Control address.

38. The multiport device of claim 36, wherein the multiport unit modifies a checksum in the first packet when the first packet is translated.

39. The multiport device of claim 36, wherein the multiport unit is configured to check whether the first packet has a predetermined purpose, and, if not, translate at least one of bits configuring the port number of the first packet into one of an identifier indicating each of the plurality of the internal terminals and a reserved port number.

40. The multiport device of claim 39, wherein the multiport unit translates the port number into the identifier when at least one bit in the port number is not used and translates the port number of the transmitted packet into the reserved port number when at least one of bit in the port number is used.
